(19) United States
(12) Patent Application Publication
(10) Pub. No.: US 2015/0006499 A1
(43) Pub. Date: Jan. 1, 2015

(54) Systems, Methods, and Computer-Readable Media for Locating Real-World Objects Using Computer-Implemented Searching

(71) Applicant: Google Inc., Mountain View, CA (US)

(72) Inventor: Benjamin Peter Stewart, Surry Hills (AU)

(21) Appl. No.: 13/930,575

(22) Filed: Jun. 28, 2013

(51) Int. Cl. G06F 17/30

(52) U.S. Cl. CPC G06F 17/30864
USPC 707/706

(57) ABSTRACT

Provided are systems, methods, and computer-readable media for locating a real-world object using a computer-implemented search engine. A real-world object may be coupled to a transmitter that periodically transmits signals having an identifier. A user device having a location may include a received that detects such signals and stores the detected identifier and signal strengths. Upon determining changes in the signal strengths of received signals from a real-world object transmitter, the user device may send the identifier, the location, and the signal strengths to a location server. Upon receiving a query for the location of the real-world object, a search engine may send a request to the location server for the location of the real-world object. The location server may obtain the identifier corresponding to the real-world object and determine the location of the real-world object based on the stored signal strengths and locations.

### BACKGROUND OF THE INVENTION

1. Field of the Invention

This invention relates generally to computer-implemented searches and, more particularly, to locating real-world objects using such searches.

2. Description of the Related Art

Small real-world objects, such as keys, remotes, smartphones, and the like are small and easily misplaced. A user of such objects may forget the previous location of the object and may be unable to locate the missing object via searching or memory. Such problems may occur even if the user typically spends most of the day in the same locations, such as a residence, a workplace, and so on. Although existing electronic location devices exist, these devices use significant amount of power. Moreover, existing electronic location devices are often too large to attach to a small real-world object such as keys. Attaching these location devices to real-world objects may make the objects bulky and reduce portability and convenience.

### SUMMARY OF THE INVENTION

Various embodiments of system, methods, and computer-readable media for locating a real-world object are provided. In some embodiments, a computer-implemented method for location a real-world object is provided. The method includes receiving over a network, at a search engine, a search query from a user device for a real-world object, the search engine configured to search digital documents accessible over a network and obtaining, via one or more processors, an identifier of a transmitter associated with the real world object. Additionally, the method further includes determining from location data, via one or more processors, the location of the real world object, the location data including one or more locations and a plurality of signal strengths and providing, via one or more processors, the location of the real world object to the user device in response to the search query.

Additionally, in some embodiments, a non-transitory tangible computer-readable storage medium having executable computer code stored thereon for locating a real-world object is provided. The code includes a set of instructions that causes one or more processors to perform the following: receiving over a network, at a search engine, a search query from a user device for a real-world object, the search engine configured to search digital documents accessible over a network and obtaining, via one or more processors, an identifier of a transmitter associated with the real world object. Additionally, the code further includes instructions that cause one or more processors to perform the following: determining from location data, via one or more processors, the location of the real world object, the location data including one or more locations and a plurality of signal strengths and providing, via one or more processors, the location of the real world object to the user device in response to the search query.

Further, in some embodiments a system for locating a real-world object is provided. The system includes a transmitter configured to be coupled to a real-world object, the transmitter configured to transmit a signal including an identifier and a receiver associated with a user device, the receiver configured to receive the signal. Additionally, the system includes a server having one or more processors and a non-transitory tangible memory accessible by the one or more processors and having executable computer code stored thereon. The code includes a set of instructions that causes one or more processors to perform the following: receiving over a network, at a search engine, a search query from a user device for the real-world object, the search engine configured to search digital documents accessible over a network and obtaining, via one or more processors, the identifier. The code further includes a set of instructions that causes one or more processors to perform the following: determining from location data, via one or more processors, the location of the real world object, the location data including one or more locations and a plurality of signal strengths and providing, via one or more processors, the location of the real world object to the user device in response to the search query.

### BRIEF DESCRIPTION OF THE DRAWINGS

FIG. 1 is a block diagram of a system for locating real-world objects using computer-implemented searching in accordance with an embodiment of the present invention;

FIG. 2 is a block diagram of a process for detecting and processing signals from a real-world object transmitter in accordance with an embodiment of the present invention;

FIG. 3 is a block diagram of a process of a location server in accordance with an embodiment of the present invention;

FIG. 4 is a block diagram of the state of an object transmitter in accordance with an embodiment of the present invention;

FIG. 5 is a block diagram of a user device in accordance with an embodiment of the present invention; and

FIG. 6 is a block diagram of a server in accordance with an embodiment of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems, methods, and computer-readable media for locating a real-world object using a computer-implemented search engine. A real-world object may be coupled to a transmitter that periodically transmits signals having an identifier. A user device having a location may include a received that detects such signals and stores the detected identifier and signal strengths. Upon determining changes in the signal strengths of received signals from a real-world object transmitter, the user device may send the identifier, the location, and the signal strengths to a location server. The location server may store and maintain an identifier and associated locations and signal strengths.

If a user loses the real-world object, the user may submit a query for the location of the real-world object to a computer-implemented search engine. The computer-implemented search engine may search digital documents, such as webpages on the World Wide Web (WWW) via a search index. Upon receiving the query for the location of the real-world object, the search engine may send a request to the location server for the location of the real-world object. The location server may obtain the identifier corresponding to the real-world object and determine the location of the real-world object based on the stored signal strengths and locations. For example, if the most recent and highest signal strength is associated with a first location, the first location may be determined as the location of the object. In another example, decreasing signal strength over a time period from a first location and an increasing signal strength over the same time period at a second location may result in a determination of the second location as the location of the object. The determined location of the real-world object is send to the search engine. The search engine may send the determined location of the real-world object to the user in response to the search query. The location may be a geographic location identified by coordinates or on a computer-generated geographic map, or the location may be a user-assigned name (e.g., “My Home Office”).

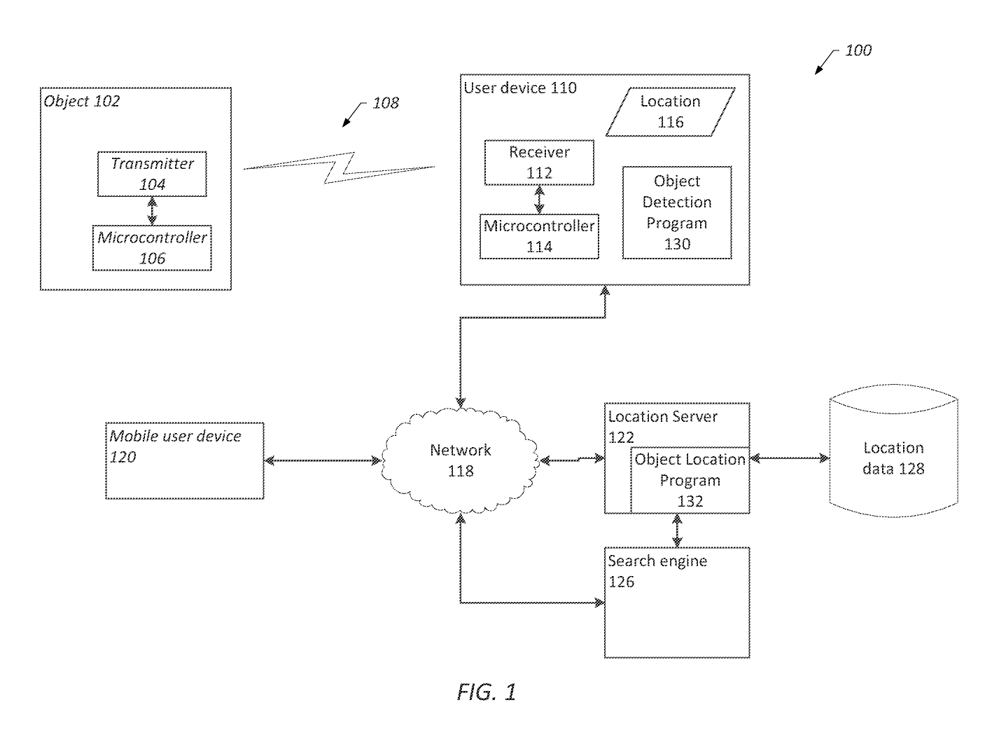

FIG. 1 depicts a system 100 for location real-world objects (e.g., object 102) using computer-implemented searching in accordance with an embodiment of the present invention. As shown in FIG. 1, the real-world object 102 may include or be coupled to a transmitter 104 and a microcontroller 106. The transmitter 104 transmits signals 108 to a user device 110 having or coupled to a receiver 112 and a microcontroller 114. As described below, the user device 110 may also include a determined location 116 used in processing the location of the real-world object 102. The system 100 also includes a network 118, a mobile user device 120, a location service 122, location data 124, and a search engine 126. As described further below, the location of the real-world object 102 may be searched for using, for example, the mobile user device 120 to send a search query to the search engine 126 via the network 118.

As shown in FIG. 1, the user devices 110 and 120, the server 122, and the search engine 126 may be in communication with the network 118, such as through a network interface having a cellular antenna, a wireless Ethernet antenna, etc. In some embodiments, the network 118 may include multiple networks, such as a wireless Ethernet network, a cellular network, or other wireless networks. Moreover, it should be appreciated that the user devices 110 and 120, the server 122, and the search engine 126 may each communicate over additional and different networks. For example, the mobile user device 120 may communicate over the network 314 and a cellular network. In another example, the search engine 126 and location server 122 may communicate between each other over a different network than network 118.

The real-world object 102 may include any real-world object for which a user desires to locate. For example, the real-world object 102 may include a key or set of keys, a remote, jewelry, a book, a wallet, a purse, or other suitable real-world objects. In some embodiments, a user may register the real-world object 110 with the location server 122, such as by assigning a name to the object 110 and identifying the transmitter (e.g., via a transmitter identifier) associated with the object 110. For example, the location server 122 may store and maintain a list of real-objects and identifiers associated with a user of the user device 110.

The microcontroller 106 may control and monitor the state of the transmitter 104 and the various transmissions sent therefrom. The transmitter 104, the microcontroller 106, or both may include a battery for providing power to such components. The transmitter 104 may transmit the signal 108 having a unique identifier according to a specified frequency. In between such transmissions, the transmitter 104 may enter a low power state to conserve battery. The transmitter 104 may implement any suitable technology or protocol, such as active Radio-Frequency Identification (RFID), passive RFID, Bluetooth, Wi-Fi Direct, NFC, any other suitable technology and protocol, or combination thereof.

The receiver 112 may be included in or coupled to the user device 110. For example, in some embodiments the user device 110 may include a personal computer, and the receiver 112 and microcontroller 114 may be a peripheral device coupled to the user device 110 via a suitable interface (e.g., Universal Serial Bus (USB), Firewire, Thunderbolt, etc.). In some embodiments, the receiver 112 may be controlled by a central processing unit (CPU) of the user device 110 and the user device 110 may not include or be coupled to the microcontroller 114. The receiver 112 may implement various suitable technologies and protocols, including RFID, Bluetooth, Wi-Fi Direct, NFC, or any other suitable technology, protocol, or combination thereof. Upon detection of the signal 108, the receiver 112 may obtain an identifier (e.g., transmitter identifier) and the strength of the received signal.

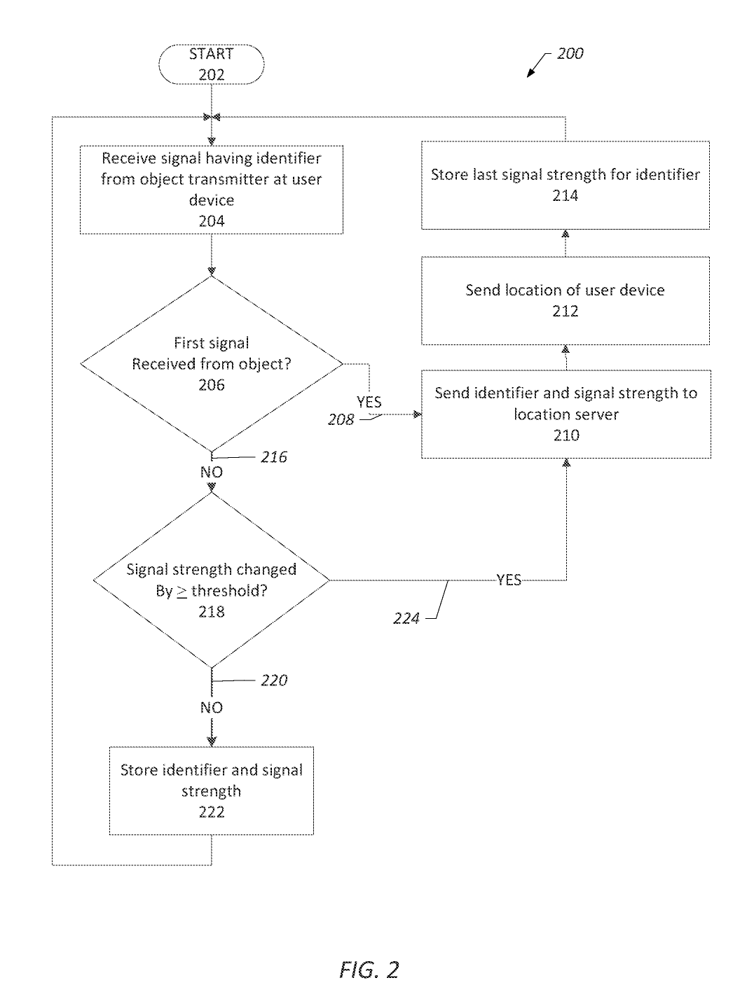

The user device 110 may include an object detection program 130 that obtains received unique identifiers and signal strengths and maintains a log of received unique identifiers and signal strengths. The object detection program 130 may monitor the log for changes in received signal strengths. Upon detection of a change in received signal strengths, the object detection program 130 may send all subsequent received unique identifiers and signal strengths to the location server 122 via the network 118, as described below and illustrated in FIG. 2. Additionally, the object detection program 130 may send the location 116 of the user device 110 to the location server 122.

As will be appreciated, the location 116 may be determined using any suitable technique or combination thereof. In some embodiments, the user device 110 may include a receiver for a satellite-based positioning system (e.g., the Global Positioning System (GPS)), and the location 116 may be determined from communications with the satellite-based positioning system. In other embodiments, the location 116 may be determined via communications with the satellite-based positioning system and other signals (e.g., Assisted GPS), such as Wi-Fi signals. In yet other embodiments, the location 116 may be determined via IP address geolocation using an IP address assigned to the user device 110. In some embodiments, the user may register the real-world object with the location server 122.

In some embodiments, a user may register the location 116 to the location server 122, such by assigning a name (e.g., “My Home Office”) to the location 116. The location server 122 may store and maintain a list of user-assigned names and locations, and may provide the user-assigned name when a location of a real-world object is determined.

The location server 122 may receive identifiers, locations, and corresponding signal strengths from the user device 110 and other user devices. The location 122 may be a single server (in a discrete hardware component or as a virtual server) or multiple servers. The location server 122 may include web servers, application servers, or other types of servers. Additionally, the location server 122 may include computers arranged in any physical and virtual configuration, such as computers in one or more data processing centers, a distributed computing environment, or other configuration. Such configurations may use the network 118 for communication or may communicate over other networks. The received identifiers, locations, and corresponding signal strengths may be stored in the location data repository 124. In some embodiments, the location data repository may be a part of the location server 122 or, in other embodiments, the location data repository 124 may be stored on a separate server accessible by the location server 122. The location data repository 124 may be a database or other suitable data structure for storing the location data. In some embodiments, the location data repository 124 may also store a list of registered real-world objects and associate identifiers, a list of locations and user-assigned names, and any other data used suitable for use with the techniques described herein.

The location server 122 may include an object location program 132 that determines a location of the transmitter 104 (and therefore the real-world object 102) using the received signals. For example, if the detected signal strength at the user device 110 has increased to a maximum over a period of time, and the detected signal strength at another user device has decreased to a minimum or zero over the same period of time, the object location program 132 may determine that the transmitter 104 (and the real-world object 102) are located near the user device 110. The determined location of the transmitter 104 may be stored in location data 124.

As shown in FIG. 1, the search engine 126 is in communication with location server 122. The search engine 126 may be implemented in a single server (in a discrete hardware component or as a virtual server) or multiple servers. Such servers may include web servers, application servers, or other types of servers. Such servers may include computers arranged in any physical and virtual configuration, such as computers in one or more data processing centers, a distributed computing environment, or other configuration. In some embodiments, the search engine 126 and the location server 122 may be implemented in the same server or group of servers, and may be provided by the same entity or different entities. For example, the search engine 126 and location server 122 may be integrated in such a manner so as to provide seamless functionality to the user for searching for real-world objects and digital documents (e.g., webpages).

As will be appreciated, the search engine 126 may include or have access to a search index for providing search results responsive to received search queries. For example, the search index may include an index of documents, such as web pages, accessible via the Internet using the World Wide Web (WWW). The search engine 126 may be accessed via a user device in various ways, such as via a web browser and webpages, a search program (e.g., a native application of a smartphone), and so on.

If a user has lost the real-world object 102, the user may send a search query to the search engine 126 using a user device, such as mobile user device 120. For example, the user may enter a search query for “my keys” and the search engine 126 may send the request to the location server 122. In some embodiments, the search engine 126 may determine the unique identifier for the real-world object 102 and send the unique identifier to the location server 122. After receiving a request from the search engine 126, the location server 122 may obtain the determined location for the transmitter 104 from the location data 124 and provide the location to the search engine 126. The search engine may send the determined location to the mobile user 120 via the network 118 as a response to the user's search query. In some embodiments, if the determined location corresponds to a geographic location, response may include a computer-implemented geographic map that displays the determined location of the transmitter 104 (and therefore the real-world object 102). In some embodiments, the determined location provided in response to the search query may be a user-assigned description for the location (e.g., “My Home Office”).

Although FIG. 1 is described with reference to the search engine 126, in other embodiments the user and the location server 122 may communicate with a different entity. For example, in some embodiments, the system 100 may additionally or alternatively include a service for providing a list of real-world objects that the user has registered. In such embodiments, the user may view the list and query the location of a real-world object, and the request for the location of the real-world object may be sent to the location server 122 and processed in the manner described above. In other embodiments, the system 100 may additionally or alternatively include a service that will display the location of a real-world object on a map. In yet other embodiments, the location server 122 may provide the location of real-world objects to various other services, engines, or other entities.

FIG. 2 depicts a process 200 for detecting and processing signals from a real-world object transmitter in accordance with an embodiment of the present invention. Some or all steps of the process 200 may be implemented as executable computer code stored on a non-transitory tangible computer-readable storage medium and executed by one or more processors of a special-purpose machine, e.g., a computer programmed to execute the code. In some embodiments, the process 200 may be implemented in object detection program 130 described above. The illustrated process 200 begins at start block 202. Initially, a signal having an identifier is received from an object transmitter at a user device (block 204). As described above, the transmitter of a real-world object may have a unique identifier that is transmitted from the transmitter. As also described above, the signals from the object transmitter are detected by a received included in or coupled to a user device (e.g., a personal computer). Using the identifier, the signal is evaluated to determine if the signal is the first signal received from the object transmitter (decision block 206). If the signal is the first signal received from the object transmitter (line 208), the identifier and signal strength are sent to the location server (block 210). Additionally, as mentioned above, the location of the user device is sent to the location server (block 212). Alternatively, in some embodiments the location server may determine the location of the user device via a token received from the user device, such as an IP address. Next, the signal strength of the revived signal is stored as the last received signal strength for the transmitter identifier (block 214), and further signals may be received (block 204).

If the received signal is not he first signal received from the object transmitter (line 216), the change between the received signal strength and a previously receives signal strength is compared to a threshold (decision block 218). If the change in signal strength is not greater or equal to the change threshold (line 220), the identifier and signal strength are stored (block 222) and the further signals may be received (block 204). If the change in signal strength is greater or equal to the change threshold (line 224), the identifier and signal strength are sent to the location server (block 210). Additionally, as described above, the location of the user device is sent to the location server (block 212) or, alternatively, in some embodiments the location server may determine the location of the user device via a token received from the user device,. Next, the signal strength of the revived signal is stored as the last received signal strength for the transmitter identifier (block 214), and further signals may be received (block 204). In this manner, a newly detected first signal of an object transmitter is send to the location server, thus indicating that an object transmitter may have been moved to near a user device. Similarly, a significant change in signal strength of signals from an object transmitter is also sent to the location server, thus indicating than an object transmitter is moving away from a user device or toward another user device.

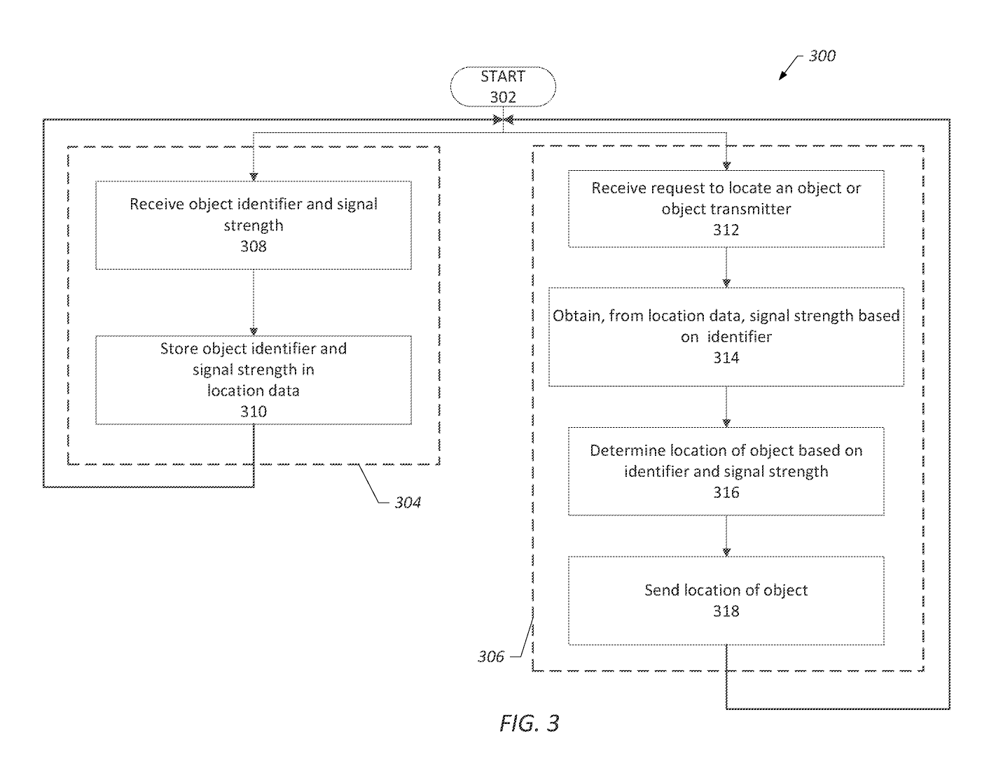

FIG. 3 depicts a process 300 of a location server in accordance with an embodiment of the present invention. Some or all steps of the process 300 may be implemented as executable computer code stored on a non-transitory tangible computer-readable storage medium and executed by one or more processors of a special-purpose machine, e.g., a computer programmed to execute the code. In some embodiments, the process 300 may be implemented in object location program 132 described above. The illustrated process 300 begins at start block 302. A first portion 304 of the process is associated with receiving and storing identifiers and signal strengths received from a user device, and a second portion 306 of the process 300 is associated with determining the location of an object transmitter. An object identifier and signal strength may be received from a user device (block 308). For example, as described above and illustrated in FIG. 2, a user device may send an identifier and signal strength to the location server if a received signal if the first received signal or if there is a significant change in signal strength. The received identifier and signal strength are stored a location data repository (block 310), such as a location data repository included in or accessible by the location server. Next, additional object identifier and signal strengths may be received (block 308) or, as described below, a request to locate an object is received.

As mentioned above, in some embodiments a request to locate an object may be received (block 312). As described above, after received a search query for a real-world object, a search engine may send a request for the object location to a location server. In some embodiments, the search engine may send an object identifier to the location server, and the location server may determine the transmitter identifier associated with the identified object. In other embodiments, the search engine may determine the transmitter identifier associated with an object of a search query and send the transmitter identifier to the location server.

Next, the signal strengths, locations, and timestamps associated with the object transmitter are obtained from a location data repository (block 314). The location of the object transmitter (and therefore the object) is determined based on the signal strengths, locations, and timestamps (block 316). For example, if the most recent and highest signal strength is associated with a first location, the first location may be determined as the location of the object. In another example, decreasing signal strength over a time period from a first location and an increasing signal strength over the same time period at a second location may result in a determination of the second location as the location of the object. As mentioned above, in some embodiments the determined location may be a geographic location identified by coordinates or other geographic identification. In other embodiments, the determined location may be a user-assigned location specific to a user device, such as “My Home Office”, “My Work”, and so on. After determining the location of the object, the object location is sent to the requesting entity, e.g., a search engine (block 318). Next, additional object identifier and signal strengths may be received (block 308) or additional requests to locate an object are received (block 310).

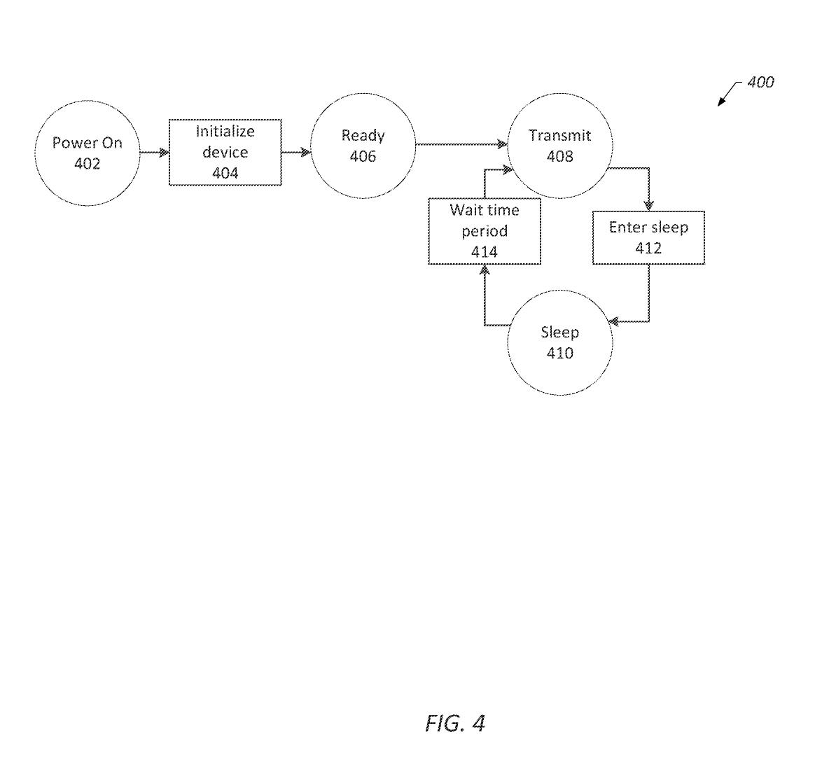

FIG. 4 is a diagram 400 that depicts the changes in state of an object transmitter (e.g., object transmitter 104) in accordance with an embodiment of the present invention. As mentioned above, in some embodiment the object transmitter is controlled via a microcontroller coupled to the transmitter. Initially, the transmitter is in a Power On state 402. The transmitter is then initialized (block 404), and the transmitter enters a Ready state 406. Next, the transmitter enters a Transmit state 408. After transmitting a signal that includes the identifier discussed above, the transmitter enters a Sleep state 410 (block 412). In the Sleep state 410, the transmitter uses a minimal amount of power. The Sleep state 410 is maintained for a wait time period (block 412). In some embodiments, for example, the wait time period is 60 seconds. After the wait time period has elapsed, the transmitter returns to the Transmit state 408 and transmits another signal having the identifier described above. Thus, after powering on and initializing, the transmitter alternates between the Transmit state 408 and the Sleep state 410 in the manner described above.

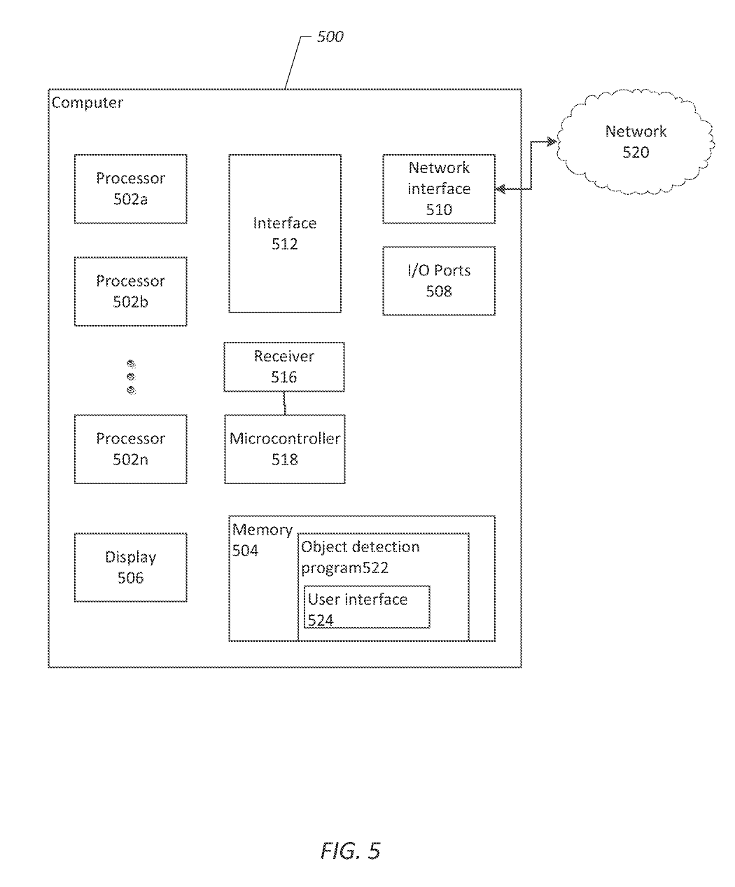

FIG. 5 is a block diagram that depicts a user device 500 in further detail and in accordance with an embodiment of the present invention. Various portions or sections of systems and processes described herein include or are executed on one or more user devices similar to user device 500 and programmed as special-purpose machines executing some or all steps of processes described above as executable computer code. The user device 500 may include various components that contribute to the function of the device and enable the user device 500 to function in accordance with the techniques discussed herein. As will be appreciated, some components of user device 500 may be provided as internal or integral components of the user device 500 and some components may be provided as external or connectable components.

User device 500 may include a combination of devices or software that may perform or otherwise provide for the performance of the techniques described herein. For example, user device 500 may include or be a combination of a desktop computer, a laptop computer, a tablet computer, a mobile telephone, a personal digital assistant (PDA), a media player, a game console, a vehicle-mounted computer, or the like. The user device 500 may be a unified device providing any one of or a combination of the functionality of a media player, a cellular phone, a personal data organizer, a game console, and so forth. In addition, the functionality provided by the illustrated components may in some embodiments be combined in fewer components or distributed in additional components. Similarly, in some embodiments, the functionality of some of the illustrated components may not be provided or other additional functionality may be available. As shown in the embodiment illustrated in FIG. 5, the user device 500 may include one or more processors (e.g., processors 502a-502n), a memory 504, a display 506, I/O ports 508 a network interface 510, and an interface 512. The user device 500 may include or be coupled to I/O devices 514. As also shown in FIG. 5 and as described above, in some embodiments the user device includes a receiver 516 that may be coupled to or include a microcontroller 518.

In addition, the user device 500 may allow a user to connect to and communicate through a network 520 (e.g., the Internet, a local area network, a wide area network, etc.) and, in some embodiments, to acquire data from a satellite-based positioning system (e.g., GPS). For example, the user device 500 may allow a user to communicate using e-mail, text messaging, instant messaging, or using other forms of electronic communication, and may allow a user to obtain the location of the device from a satellite-based positioning system.

In some embodiments, the display 506 may include a liquid crystal display (LCD) an organic light emitting diode (OLED) display, or other display types. In some embodiments, the display 506 may include or be provided in conjunction with touch sensitive elements through which a user may interact with the user interface. In such embodiments, a touch-sensitive display may be referred to as a “touch screen” and may also be known as or called a touch-sensitive display system.

The processor 502 may provide the processing capability to execute the operating system, programs, user interface, and other functions of the user device 500. The processor 502 may include one or more processors and may include “general-purpose” microprocessors, special purpose microprocessors, such as application-specific integrated circuits (ASICs), or any combination thereof. In some embodiments, the processor 502 may include one or more reduced instruction set (RISC) processors, such as those implementing the Advanced RISC Machine (ARM) instruction set. Additionally, the processor 502 may include single-core processors and multicore processors and may include graphics processors, video processors, and related chip sets. Accordingly, the user device 500 may be a uni-processor system having one processor (e.g., processor 502a), or a multi-processor system having two or more suitable processors (e.g., 502a-502n). Multiple processors may be employed to provide for parallel or sequential execution of the techniques described herein. The processor 502 may receive instructions and data from a memory (e.g., system memory 504).

The memory 504 (which may include one or more tangible non-transitory computer readable storage mediums) may include volatile memory and non-volatile memory accessible by the processor 502 and other components of the user device 500. For example, the memory 504 may include volatile memory, such as random access memory (RAM). The memory 504 may also include non-volatile memory, such as ROM, flash memory, a hard drive, other suitable optical, magnetic, or solid-state storage mediums or any combination thereof. The memory 504 may store a variety of information and may be used for a variety of purposes. For example, the memory 504 may store executable computer code, such as the firmware for the user device 500, an operating system for the user device 500, and any other programs or other executable code for providing functions of the user device 500. Such executable computer code may include program instructions executable by a processor (e.g., one or more of processors 502a-502n) to implement one or more embodiments of the present invention. Program instructions may include computer program instructions for implementing one or more techniques described herein. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including a stand-alone program, a module, a component, a subroutine, and the like. A computer program may or may not correspond to a file in a file system. A computer program may be stored in a section of a file that holds other computer programs or data (e.g., one or more scripts stored in a markup language document), in a single file dedicated to the program in question, or in multiple coordinated files (e.g., files that store one or more modules, sub programs, or sections of code).

As shown in FIG. 5, in some embodiments the program instructions may define an object location application 522. As described above, the object location application 522 may process received signals received at the receiver 516. Additionally, in some embodiments the object location application 522 may include a user interface 524 that enables a user to enter and view information about a real-world object, a location, and other items.

The interface 512 may include multiple interfaces and may enable communication between various components of the user device 500, the processor 502, and the memory 504. In some embodiments, the interface 512, the processor 502, memory 504, and one or more other components of the user device 500 may be implemented on a single chip, such as a system-on-a-chip (SOC). In other embodiments, these components, their functionalities, or both may be implemented on separate chips. The interface 512 may coordinate I/O traffic between processors 502a-502n, the memory 504, the network interface 510, 514, or any other devices or a combination thereof. The interface 512 may include various types of interfaces for connecting additional components, such as Peripheral Component Interconnect (PCI) interfaces, the Universal Serial Bus (USB) interfaces, Thunderbolt interfaces, Firewire (IEEE-1394) interfaces, and so on.

The user device 500 may also include an input and output port 508 to enable connection of additional devices, such as I/O devices. Embodiments of the present invention may include any number of input and output ports 508, including headphone and headset jacks, universal serial bus (USB) ports, Firewire (IEEE-1394) ports, Thunderbolt ports, and AC and DC power connectors. Further, the user device 500 may use the input and output ports to connect to and send or receive data with any other device, such as other portable computers, personal computers, printers, etc. In some embodiments, the receiver 516 may be external to the user device 500 and may be connected via the input and output port 508.

The receiver 516 and microcontroller 518 may operate in the manner described above. In some embodiments, the receiver 516 is integrated in the user device 500. In other embodiments, the receiver 516 is an external device coupled to the user device 500. The receiver 516 may implement various suitable technologies and protocols, including RFID, Bluetooth, Wi-Fi Direct, NFC, or any other suitable technology, protocol, or combination thereof. In some embodiments, the receiver 516 is a passive receiver. In other embodiments, the receiver 516 may be an active received and operate with passive transmitters, such as passive RFID tags.

The user device 500 depicted in FIG. 5 also includes a network interface 510. The network interface 510 may include a wired network interface card (NIC), a wireless (e.g., radio frequency) network interface card, or combination thereof. The network interface 510 may include known circuitry for receiving and sending signals to and from communications networks, The network interface 510 may communicate with networks (e.g., network 516), such as the Internet, an intranet, a cellular telephone network, a wide area network (WAN), a local area network (LAN), a metropolitan area network (MAN), or other devices by wired or wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11 standards), voice over Internet Protocol (VoIP), Wi-MAX, an email protocol, message-oriented protocols, or any other suitable communications standards, protocols, and technologies.

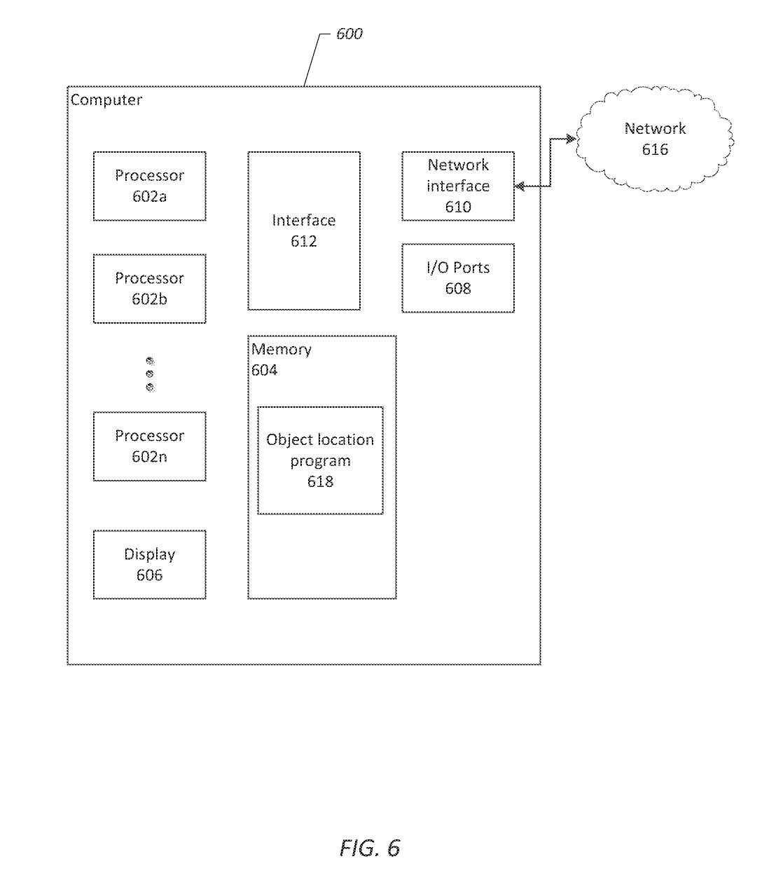

FIG. 6 depicts a block diagram of a server 600, e.g., a location server, in accordance with an embodiment of the present invention. In some embodiments, services, engines, or other entities described herein may be implemented on one or multiple instances of the server 600. Various portions or sections of systems and processes described above include or are executed on one or more servers similar to server 600 and programmed as special-purpose machines executing some or all steps of processes described above as executable computer code. The server 600 may include various components that contribute to the function of the device and enable the server 600 to function in accordance with the techniques discussed herein. As will be appreciated, some components of server 600 may be provided as internal or integral components of the server 600 and some components may be provided as external or connectable components. Server 600 may include a combination of devices or software that may perform or otherwise provide for the performance of the techniques described herein. For example, server 600 may include or be a combination of a cloud-computing system, a data center, a server rack or other server enclosure, a server, a virtual server, a desktop computer, a laptop computer, or the like. Server 600 may be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available. As shown in the embodiment illustrated in FIG. 6, the server 600 may include one or more processors (e.g., processors 602a-602n), a memory 604, a display 606, I/O ports 608 a network interface 610, and an interface 612. In addition, the server 600 may allow a user to connect to and communicate through a network 616 (e.g., the Internet, a local area network, a wide area network, etc.).

In some embodiments, the display 606 may include a liquid crystal display (LCD) an organic light emitting diode (OLED) display, or other display types. The display 606 may display a user interface (e.g., a graphical user interface) executed by the processor 602 of the server 600. In some embodiments, the display 606 may include or be provided in conjunction with touch sensitive elements through which a user may interact with the user interface, i.e., a touch screen or a touch sensitive display elements.

The processor 602 may provide the processing capability to execute the operating system, programs, user interface, and other functions of the server 600. The processor 602 may include one or more processors and may include “general-purpose” microprocessors, special purpose microprocessors, such as application-specific integrated circuits (ASICs), or any combination thereof. In some embodiments, the processor 602 may include one or more reduced instruction set (RISC) processors, such as those implementing the Advanced RISC Machine (ARM) instruction set. Additionally, the processor 602 may include single-core processors and multicore processors and may include graphics processors, video processors, and related chip sets. Accordingly, the server 600 may be a uni-processor system having one processor (e.g., processor 602a), or a multi-processor system having two or more suitable processors (e.g., 602a-602n). Multiple processors may be employed to provide for parallel or sequential execution of the techniques described herein. The processor 602 may receive instructions and data from a memory (e.g., system memory 604).

The memory 604 (which may include one or more tangible non-transitory computer readable storage mediums) may include volatile memory and non-volatile memory accessible by the processor 602 and other components of the server 600. For example, the memory 604 may include volatile memory, such as random access memory (RAM). The memory 604 may also include non-volatile memory, such as ROM, flash memory, a hard drive, other suitable optical, magnetic, or solid-state storage mediums or any combination thereof. The memory 604 may store a variety of information and may be used for a variety of purposes. For example, the memory 604 may store executable computer code, such as the firmware for the server 600, an operating system for the server 600, and any other programs or other executable code for providing functions of the server 600. Such executable computer code may include program instructions 618 executable by a processor (e.g., one or more of processors 602a-602n) to implement one or more embodiments of the present invention. Program instructions may include modules of computer program instructions for implementing one or more techniques described herein. Program instructions may include a computer program (which in certain forms is known as a program, software, software application, script, or code). A computer program may be written in a programming language, including compiled or interpreted languages, or declarative or procedural languages. As shown in FIG. 6, in some embodiments the program instructions may define an object location program 618. As described above, the object location program 618 may receive identifiers (e.g., transmitter identifiers), locations, and signal strengths from a user device. As also described above, the identifiers, locations, and signal strengths may be stored in a location data repository. In response to a request for the location of a real-world object, such as request received from a search engine, the object location program 618 may determine the location of the real-world object using the location data and send the location to the requesting entity.

The interface 612 may include multiple interfaces and may enable communication between various components of the server 600, the processor 602, and the memory 604. In some embodiments, the interface 612, the processor 602, memory 604, and one or more other components of the server 600 may be implemented on a single chip, such as a system-on-a-chip (SOC). In other embodiments, these components, their functionalities, or both may be implemented on separate chips. The interface 612 may coordinate I/O traffic between processors 602a-602n, the memory 604, the network interface 610, 614, or any other devices or a combination thereof. The interface 612 may implement various types of interfaces for connected external devices, such as Peripheral Component Interconnect (PCI) interfaces, the Universal Serial Bus (USB) interfaces, Thunderbolt interfaces, Firewire (IEEE-1394) interfaces, and so on.

The server 600 may also include an input and output port 608, including headphone and headset jacks, universal serial bus (USB) ports, Firewire (IEEE-1394) ports, Thunderbolt ports, and AC and DC power connectors, to enable connection of additional devices, such as I/O devices.

The server 600 depicted in FIG. 6 also includes a network interface 610. The network interface 610 may include a wired network interface card (NIC), a wireless (e.g., radio frequency) network interface card, or combination thereof. The network interface 610 may include known circuitry for receiving and sending signals to and from communications networks. The network interface 610 may communicate with networks (e.g., network 616), such as the Internet, an intranet, a cellular telephone network, a wide area network (WAN), a local area network (LAN), a metropolitan area network (MAN), or other devices by wired or wireless communication. The communication may use any suitable communications standard, protocol and technology, including those listed above with regard to the user device 500.

Various portions or sections of systems and methods described herein include or are executed on one or more computers similar to computer 400 and programmed as special-purpose machines executing some or all steps of methods described above as executable computer code. Further, processes and modules described herein may be executed by one or more processing systems similar to that of computer 400.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for locating a real-world object, the method comprising:
receiving over a network, at a search engine, a search query from a user device for a real-world object, the search engine configured to search digital documents accessible over a network;
obtaining, via one or more processors, an identifier of a transmitter associated with the real world object;
determining from location data, via one or more processors, the location of the real world object, the location data comprising one or more locations and a plurality of signal strengths; and
providing, via one or more processors, the location of the real world object to the user device in response to the search query.

2. The computer-implemented method of claim 1, wherein the search query comprises one or more terms that identify the real-world object.

3. The computer-implemented method of claim 2, wherein obtaining an identifier of a transmitter associated with the real world object comprises obtaining the identifier based on the one or more terms.

4. The computer-implemented method of claim 1, wherein the location comprises a set of geographic coordinates or a user-assigned name.

5. The computer-implemented method of claim 1, wherein the location of the real world object is based on an identification of the most recent signal strengths of the plurality of signal strengths.

6. The computer-implemented method of claim 1, wherein the user device comprises a desktop computer, a laptop computer, or a smartphone.

7. The computer-implemented method of claim 1, wherein providing the location of the real-world object to the user device comprises providing a marker at the location on a computer-generated geographic map.

8. The computer-implemented method of claim 1, comprising:
receiving a signal from the transmitter at a second user device;
determining whether the change between the received signal strength and a previously received signal strength is above a threshold;
transmitting, over a network, the user device location and a signal strength indicator to a server.

9. A non-transitory tangible computer-readable storage medium having executable computer code stored thereon for locating a real-world object, the code comprising a set of instructions that causes one or more processors to perform the following:
receiving over a network, at a search engine, a search query from a user device for a real-world object, the search engine configured to search digital documents accessible over a network;
obtaining, via one or more processors, an identifier of a transmitter associated with the real world object;
determining from location data, via one or more processors, the location of the real world object, the location data comprising one or more locations and a plurality of signal strengths; and
providing, via one or more processors, the location of the real world object to the user device in response to the search query.

10. The non-transitory tangible computer-readable storage medium of claim 9, wherein the search query comprises one or more terms that identify the real-world object.

11. The non-transitory tangible computer-readable storage medium of claim 10, wherein obtaining an identifier of a transmitter associated with the real world object comprises obtaining the identifier based on the one or more terms.

12. The non-transitory tangible computer-readable storage medium of claim 9, wherein the location comprises a set of geographic coordinates or a user-assigned name.

13. The non-transitory tangible computer-readable storage medium of claim 9, wherein the location of the real world object is based on an identification of the most recent signal strengths of the plurality of signal strengths.

14. The non-transitory tangible computer-readable storage medium of claim 9, wherein the user device comprises a desktop computer, a laptop computer, or a smartphone.

15. The non-transitory tangible computer-readable storage medium of claim 9, wherein providing the location of the real-world object to the user device comprises providing a marker at the location on a computer-generated geographic map.

16. The non-transitory tangible computer-readable storage medium of claim 9, wherein the transmitter is configured to periodically transmit a signal with the identifier.

17. A system, comprising:
a transmitter configured to be coupled to a real-world object, the transmitter configured to transmit a signal including an identifier;
a receiver associated with a user device, the receiver configured to receive the signal;
a server comprising:
one or more processors; and
a non-transitory tangible memory accessible by the one or more processors and having executable computer code stored thereon, the code comprising a set of instructions that causes one or more processors to perform the following:
receiving over a network, at a search engine, a search query from a user device for the real-world object, the search engine configured to search digital documents accessible over a network;
obtaining, via one or more processors, the identifier;
determining from location data, via one or more processors, the location of the real world object, the location data comprising one or more locations and a plurality of signal strengths; and
providing, via one or more processors, the location of the real world object to the user device in response to the search query.

18. The system of claim 17, comprising a location data repository accessible by the server, wherein the location data repository stored the location data.

19. The system of claim 17, wherein the search query comprises one or more terms that identify the real-world object.

20. The system of claim 17, The computer-implemented method of claim 1, wherein the location of the real world object is based on an identification of the most recent signal strengths of the plurality of signal strengths.
